(19) United States
(12) Patent Application Publication
(10) Pub. No.: US 2006/0249384 A1
(43) Pub. Date: Nov. 9, 2006

(54) Chemical sensor

(76) Inventors: Yong Shin Kim, Daejeon (KR); Seung Chul Ha, Suwon (KR); Yoon Seok Yang, Daejeon (KR); Hae Sik Yang, Daejeon (KR); Youn Tae Kim, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/192,954

(22) Filed: Jul. 27, 2005

(30) Foreign Application Priority Data
Dec. 22, 2004 (KR) 2004-110716

(51) Int. Cl. G01N 27/26

(52) U.S. Cl. 204/424

(57) ABSTRACT

Provided is a chemical sensor for detecting a gaseous chemical species including a sensing layer made of a crystalline metal oxide nanoparticle aggregate having an aspect ratio of not less than about 5, and a short side length of not more than about 2 nm, whereby it is possible to detect the chemical species even at a room temperature since electrical conductivity is varied depending on adsorption and desorption of the chemical species due to a large surface area of the crystalline metal oxide nanoparticle and an active adsorption site located at a surface thereof.

### CROSS-REFERENCE TO RELATED APPLICATION

This application claims the benefit of Korean Patent Application No. 2004-110716, filed Dec. 22, 2004, the disclosure of which is hereby incorporated herein by reference in its entirety.

### BACKGROUND

1. Field of the Invention

The present invention relates to a chemical sensor for detecting a gaseous chemical species and, more particularly, to a chemical sensor including a sensing layer made of a crystalline metal oxide nanoparticle aggregate having an aspect ratio of not less than 5 and a short side length of not more than 6 nm.

2. Discussion of Related Art

In order to detect a chemical species existing in a gaseous state, generally, an analysis instrument such as a gas chromatography or a weight analyzer is used, or a sensor that various physical factors are varied depending on a certain chemical species is used. The former corresponds to a typical analysis instrument having an individual system, and the latter corresponds to a part for detection in the system for detecting a chemical species.

Sensor technologies for detecting a gaseous chemical species generally include an oxide semiconductor technology typically using SnO₂, a quartz crystal microbalance (QCM) using bulk acoustic, a surface acoustic wave (SAW) device using surface acoustic, a conductive polymer device utilizing conducting polymer, a composite device composed of conductive particles and non-conductive polymer, and a calorimetric technology using optical absorption or reflection phenomena.

A sensor using the oxide semiconductor technology is configured to allow the chemical species to be adsorbed to the crystalline metal oxide having semiconductor characteristics, and detects whether the chemical species exists or not using the theory that concentration of a carrier is changed, which plays a decisive role to perform electric conduction by surface reaction of oxygen adsorbates and the chemical species. Typical metal oxides may be SnO₂, WO₃, In₂O₃ and so on.

In order to maximize sensitivity of the sensor, researches for making a particle size of the crystalline metal oxide as small as a nano meter have been conducted (MRS Bull, 1999, 18).

The sensor using the metal oxide generally includes a metal electrode, metal oxide formed on the metal electrode using various semiconductor deposition methods, and a heater adjusting a reaction temperature. These sensors have high sensitive characteristics with respect to a molecule having large oxidation and reduction properties, can be manufactured with low cost, and can be manufactured by a typical semiconductor process. However, it is difficult to manufacture the sensor, and power consumption is large since the sensor should be operated at a high temperature of about 200˜500° C.

In order to solve the problem of large power consumption, technologies of reducing an area of a sensing part using an MEMS (micro-electromechanical system), disposing a microscopic heater adjacent to the sensing part, and introducing a structure reducing a heat loss have been attempted.

For example, U.S. Pat. No. 6,596,236 (Jul. 7, 2003) discloses a technology of manufacturing a small hydrogen sensor using a sensing layer, a heater, and a porous structure.

A method of minimizing the heat loss of the microheater is widely used in a small metal oxide sensor driving at low power, however, in order to manufacture the sensor, the MEMS fabrication processes should be employed. Currently, while various methods of fabricating a sensor structure with a heater using the MEMS have been developed. However, in order to implement the methods, various auxiliary equipments are required and it is necessary to develop technologies for obtaining yield and reliability. Therefore, development of a sensing layer drivable at low power and room temperature may be substantial solution.

In order to increase sensitivity of the sensor, a technology using nanoparticles has been researched. That is, a technology of forming a sensing layer using non-crystalline particles and forming crystalline particles of not more than several nm by introducing the following heat treatment or auxiliary additives has been researched. Nowadays, it is difficult to implement a sensor drivable at room temperature and having high reliability.

### SUMMARY OF THE INVENTION

The present invention, therefore, solves aforementioned problems associated with conventional devices by providing a chemical sensor capable of detecting a gaseous chemical species using low power at room temperature.

The present invention also provides a chemical sensor using variations of electrical conductivity depending on adsorption and desorption of a chemical species other than chemical reaction.

In an exemplary embodiment of the present invention, a chemical sensor for detecting a gaseous chemical species includes a sensing layer at which the chemical species is adsorbed, and at least two electrodes for measuring variations of electrical conductivity of the sensing layer, wherein the sensing layer is formed of a metal oxide nanoparticle aggregate.

The metal oxide nanoparticle may have an aspect ratio of about 5 to 70, and a short side length of about 2 to 6 nm. For example, when the nanoparticle is manufactured by a method of fabricating a nanowire using cadmium sulfide, it is possible to manufacture in the aforementioned range, and to use as a sensing layer in the aforementioned size.

The metal oxide nanoparticle may be one selected from SnOx, WOx, TiOx, TaOx, ZnO, and InOx, and metal atoms could be added to the metal oxide or WO_{2.72} as additive materials.

The metal atom may be one selected from Pd, Pt, Ru, V, Cu, Au, Cd, and Al.

### BRIEF DESCRIPTION OF THE DRAWINGS

The above and other features of the present invention will be described in reference to certain exemplary embodiments thereof with reference to the attached drawings in which:

FIG. 1 is a cross-sectional view of a chemical sensor in accordance with a first embodiment of the present invention;

FIG. 2 is a plan view of the sensing electrode shown in FIG. 1;

FIG. 3 is a cross-sectional view of a chemical sensor in accordance with a second embodiment of the present invention;

FIG. 4 is a cross-sectional view of a chemical sensor in accordance with a third embodiment of the present invention;

FIG. 5 is a cross-sectional view of a chemical sensor in accordance with a fourth embodiment of the present invention;

FIG. 6 is a cross-sectional view of a chemical sensor in accordance with a fifth embodiment of the present invention;

FIG. 7 is a photograph showing a plane of the chemical sensor shown in FIG. 6;

FIG. 8 is a scanning electron microscope (SEM) photograph of a sensing layer made of tungsten oxide;

FIG. 9 is an X-ray diffraction spectrum of a sensing layer made of tungsten oxide;

FIG. 10 is an X-ray photoelectron spectrum of a sensing layer made of tungsten oxide;

FIG. 11 is a graph showing sensing reaction to ammonia;

FIG. 12 is a graph showing sensing characteristics depending on variations of ammonia concentration;

FIG. 13 is a graph showing sensing characteristics depending on an increase of ethanol concentration;

FIG. 14 is a graph showing sensitivity levels depending on variations of ethanol concentration;

FIG. 15 is a graph showing sensing characteristics depending on injection and elimination of ethanol, toluene, n-heptanes, and acetone;

FIG. 16 is a graph showing sensing characteristics depending on thickness of a sensing layer;

FIG. 17 is a graph showing sensing characteristics depending on injection and elimination of ethanol and variations of recovering time depending on UV light irradiation; and

FIG. 18 is a graph showing sensing characteristics when a pulse voltage is applied to a heater.

### DETAILED DESCRIPTION OF PREFERRED EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity.

In a conventional art, since a chemical species is detected using variations of electrical conductivity depending on surface reaction of oxygen adsorbates and the chemical species, it is necessary to maintain a high temperature state for chemical reaction. However, the present invention is capable of detecting the chemical species even at a room temperature since using the theory that the electrical conductivity is varied as the gaseous chemical species is adsorbed and desorbed on from a surface of a sensing layer made of metal oxide nanoparticles is used.

In order to adopt the theory, the present invention uses the metal oxide nanoparticles having a large surface area and an active adsorption site at the surface. In addition, the sensing layer is formed of a crystalline metal oxide nanoparticle aggregate having an aspect ratio of not less than 5 and a short side length of not more than 6 nm.

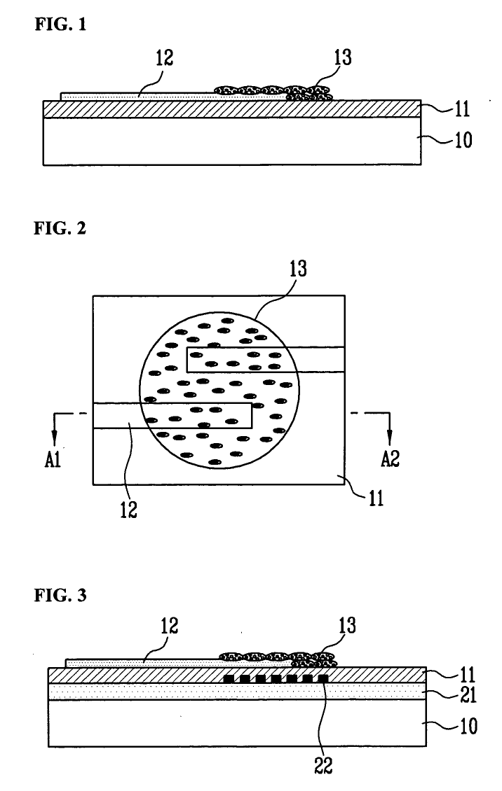

FIG. 1 is a cross-sectional view of a chemical sensor in accordance with a first embodiment of the present invention.

An insulating layer 11 is formed on a substrate 10, and a sensing electrode 12 is formed on the insulating layer 11. In addition, a sensing layer 13 is formed on the insulating layer 11 including the sensing electrode 12.

The substrate 10 may employ a silicon substrate, a GaAs substrate, a glass substrate, a ceramic substrate, a plastic substrate, and so on.

The insulating layer 11 functions to maintain electrical insulation between the sensing electrode 12 and a lower structure, and physically support the sensing electrode 12 and the sensing layer 13. Therefore, preferably, the insulating layer 11 is formed of an oxide layer, a nitride layer or a stacked layer of an oxide layer and a nitride layer which has high insulation performance, high structural stability, and excellent adhesive performance between upper and lower layers, without generating problems such as an internal stress.

As shown in FIG. 2, the sensing electrodes 12 may be arranged in a comb shape that negative and positive electrodes are alternately disposed to maximize a contact area, or in a straight line that the negative and positive electrodes are aligned parallel to each other. Each sensing electrode 12 includes a pad (not shown) to be in electrical contact with a connecting wire. The sensing electrode 12 may be formed of Au, Pt, Al, Mo, Ag, TiN, W, Ru, Ir, poly-Si or the like, and may include an auxiliary material for improving adhesion between a deposition subject and a metal material before depositing the material.

The sensing electrode 12 may be formed of a thin layer or a thick layer of a conductive material. In the case of the thin layer, the sensing electrode 12 is deposited by a vacuum deposition method and then patterned, and in the case of the thick layer, a mixture of conductive metal particles and organic materials is screen-printed.

The sensing layer 13 is made of a metal oxide nanoparticle aggregate. Preferably, each metal oxide nanoparticle has an aspect ratio of not less than 5, for example 5 to 70, and a short side length of not more than 6 nm, for example 2 to 6 nm.

The metal oxide nanoparticle may typically use, for example, SnOx, WOx, TiOx, TaOx, ZnO, InOx or the like, or tungsten oxide (WO_{2.72}), and a metal atom such as Pd, Pt, Ru, V, Cu, Au, Cd, Al, or the like may be added to the metal oxide in order to adjust sensitivity and selectivity of the sensor.

The metal oxide nanoparticle may be fabricated using various methods such as a chemical vapor deposition (CVD) method, a synthetic method using arc, a template method using anode aluminum oxide or polycarbonate membrane polymer, a solvothermal method using heat and surfactant in solution, and so on. In the present invention, the metal oxide nanoparticles fabricated by the methods are separated and refined, and then, dispersed in solution. An ideal method may be the solvothermal method for synthesizing them in the solution.

The metal oxide nanoparticles dispersed in solvent are applied using a drop coating (dispensing) method, a spin coating method, a spray coating method, or a dip coating method to form the sensing layer 13. At this time, preferably, the sensing layer 13 is formed to a thickness of about 0.1˜10 μm. The solvent may use an organic solvent, and when the dispersion is not performed due to low solubility between the solvent and the nanoparticles, the dispersion is induced using physical impact such as ultrasonic waves. In addition, the applied metal oxide nanoparticles include various solvent molecules to apply heat or maintain vacuum conditions to facilitate elimination of the solvent. If necessary, auxiliary additives capable of facilitating dispersion and improving characteristics of the nanoparticles may be mixed.

FIG. 3 is a cross-sectional view of a chemical sensor in accordance with a second embodiment of the present invention. In the structure of the chemical sensor of FIG. 1, a heater 22 made of metal lines is formed in the insulating layer 11 under the sensing layer 13, and isolated from the substrate 10 by interposing an isolation layer 21.

The heater 22 may be formed of a thin layer or a thick layer of a conductive material. In the case of the thin layer, the heater12 is deposited using a vacuum deposition method and then patterned in a microscopic heater shape, and in the case of the thick layer, a mixture of conductive metal particles and organic materials is screen-printed. The conductive material typically employs Au, Pt, Al, Mo, Ag, TiN, W, Ru, Ir, poly-Si and so on. An auxiliary material may be formed to improve adhesion between a deposition subject and the metal material before deposition of the conductive material. For example, Cr or Ti may be formed on glass or silicon to improve adhesion of Au or Pt. In addition, when the heater 22 is formed, a temperature sensor for measuring a temperature may be simultaneously manufactured, and the heater 22 may be formed using a material that can simultaneously perform this sensor function. Pt, poly-Si and so on may be used as a typical material.

The heater 22 functions to maintain the sensing layer 13 at a constant temperature of not more than 100° C., and the isolation layer 21 functions to prevent the substrate 10 from being heated. Therefore, the isolation layer 21 has an insulation characteristic and a fine structure, and preferably, formed of an oxide layer or a nitride layer capable of definitely isolating the substrate and the heater thermally and physically.

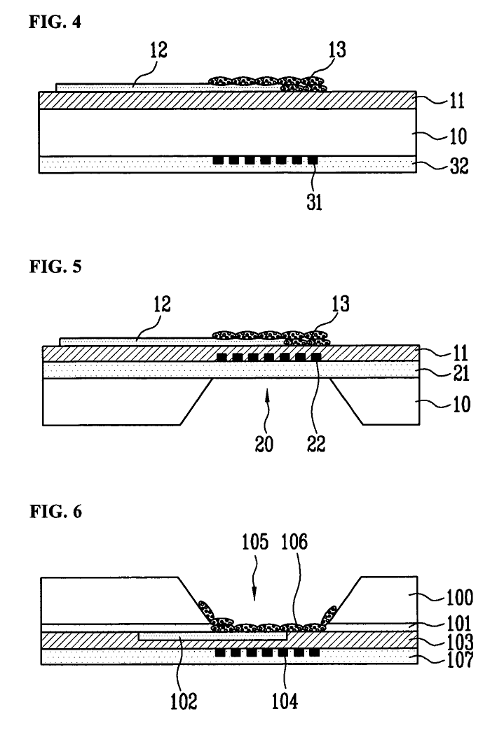

FIG. 4 is a cross-sectional view of a chemical sensor in accordance with a third embodiment of the present invention. In the structure of the chemical sensor of FIG. 1, a heater 31 made of metal lines is formed at a bottom surface of the substrate 10 under the sensing layer 13, and a passivation layer 32 is formed on the bottom surface 10 of the substrate 10 including the heater 31. In the embodiment, preferably, the substrate 10 uses a ceramic substrate such as alumina having excellent thermal conductivity and insulation characteristics.

The passivation layer 32 functions to prevent the heat generated from the heater 31 and the electricity flowing through the heater 31 from leaking to the exterior. Therefore, the passivation layer 32 may be formed of an oxide layer or a nitride layer having an insulation characteristic and a fine structure, or may be formed of a thick layer using insulating paste.

FIG. 5 is a cross-sectional view of a chemical sensor in accordance with a fourth embodiment of the present invention. In the structure of the chemical sensor of FIG. 3, in order to minimize a heat loss generated from the heater 22, a chamber 20 is formed on the substrate 10 under the heater 22 to expose the isolation layer 21. Preferably, the chamber 20 is formed by an MEMS process, in this case; preferably, a silicon substrate is used for the substrate 10.

For example, the substrate 10 is isotropically etched by a dry etching method such as deep reactive ion etching (DRIE) or a wet etching method using KOH or tri-methyl ammonium hydroxide (TMAH) as etchant to form the chamber 20. In the case of using another kind of substrate such as plastic, glass, ceramic and so on, first, the chamber 20 is formed on the substrate 10. For example, a plastic film is laminated on the substrate 10, at which the heater 22 is to be formed, in the state that the chamber 20 was formed, thereby forming the isolation layer 21.

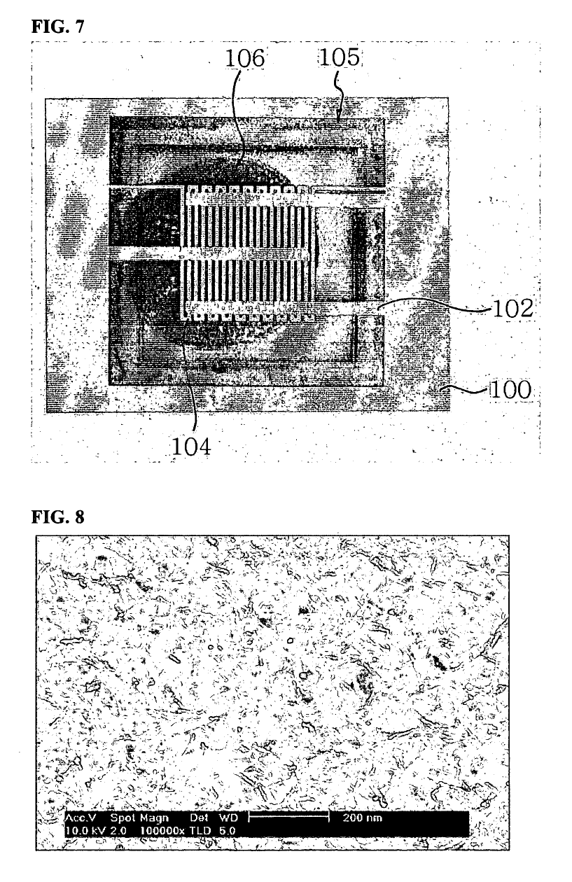

FIG. 6 is a cross-sectional view of a chemical sensor in accordance with a fifth embodiment of the present invention, and FIG. 7 is a photograph showing a plan structure of FIG. 6.

An isolation layer 101 is formed on a surface of a substrate 100, and a sensing electrode 102 is formed on the isolation layer 101. An insulating layer 103 is formed on the isolation layer 101 including the sensing electrode 102, a heater 104 is formed on the insulating layer 103, and a passivation layer 107 is formed on the insulating layer 103 including the heater 104.

A chamber 105 is formed on the substrate 100 under the heater 104 to minimize a heat loss generated from the heater 104, and a sensing layer 106 is formed on the sensing electrode 102 exposed through the chamber 105

The substrate 100 may use a silicon substrate, a GaAs substrate, a glass substrate, a ceramic substrate, a plastic substrate and so on, however, preferably, uses the silicon substrate in order to form the chamber 105 using an MEMS process.

For example, the substrate 100 is isotropically etched by a dry etching method such as deep reactive ion etching (DRIE) or a wet etching method using KOH or tri-methyl ammonium hydroxide (TMAH) as etchant to form the chamber 105. In the case of using another kind of substrate such as plastic, glass, ceramic and so on, first, the chamber 105 is formed on the substrate 100. For example, a plastic film is laminated on the substrate 100, at which the heater 104 is to be formed, in the state that the chamber 105 was formed, thereby forming the isolation layer 101.

The insulating layer 103 functions to maintain electrical insulation between the sensing electrode 102 and a lower structure, and physically support the sensing electrode 102 and the sensing layer 106. Therefore, preferably, the insulating layer 103 is formed of an oxide layer, a nitride layer or a stacked layer of an oxide layer and a nitride layer which has high structural stability and excellent adhesive performance between upper and lower layers, without generating problems such as an internal stress.

The heater 104 may be formed of a thin layer or a thick layer of a conductive material. In the case of the thin layer, the heater 104 is deposited by a vacuum deposition method and then patterned in a microscopic heater shape, and in the case of the thick layer, a mixture of conductive metal particles and organic materials is screen-printed. The conductive material typically employs Au, Pt, Al, Mo, Ag, TiN, W, Ru, Ir, poly-Si and so on. An auxiliary material may be formed to improve adhesion between a deposition subject and the metal material before deposition of the conductive material. For example, Cr or Ti may be formed on glass or silicon to improve adhesion of Au or Pt. In addition, when the heater 104 is formed, a temperature sensor for measuring a temperature may be simultaneously manufactured, and the heater 104 may be formed using a material that can simultaneously perform this sensor function. Pt, poly-Si and so on may be used as a typical material.

The heater 104 functions to maintain the sensing layer 106 at a constant temperature of not more than 100° C. At this time, the isolation layer 101 functions to prevent the substrate 100 from being heated. Therefore, the isolation layer 101 has an insulation characteristic and a fine structure, and preferably, formed of an oxide layer or a nitride layer capable of definitely isolating the substrate 100 and the heater 104 thermally and physically.

The passivation layer 107 functions to prevent the heat generated from the heater 104 and the electricity flowing through the heater 104 from leaking to the exterior. Therefore, the passivation layer 107 may be formed of an oxide layer or a nitride layer having an insulation characteristic and a fine structure, or may be formed of a thick layer using insulating paste.

Preferably, the chamber 105 is formed by an MEMS process; therefore, preferably, a silicon substrate is uses for the substrate 100.

As shown in FIG. 7, the sensing electrodes 102 may be arranged in a comb shape that negative and positive electrodes are alternately disposed, or in a straight line that the negative and positive electrodes are aligned parallel to each other. Each sensing electrode 102 includes a pad (not shown) to be in electrical contact with a connecting wire. The sensing electrode 102 may be formed of Au, Pt, Al, Mo, Ag, TiN, W, Ru, Ir, poly-Si or the like, and may include an auxiliary material for improving adhesion between a deposition subject and a metal material before depositing this material.

The sensing electrode 102 may be formed of a thin layer or a thick layer of a conductive material. In the case of the thin layer, the sensing electrode 102 is deposited by a vacuum deposition method and then patterned, and in the case of the thick layer, a mixture of conductive metal particles and organic materials is screen-printed.

The sensing layer 106 is made of a metal oxide nanoparticle aggregate. Preferably, each metal oxide nanoparticle has an aspect ratio of not less than 5, for example 5 to 70, and a short side length of not more than 6 nm, for example 2 to 6 nm. The metal oxide nanoparticle may typically use, for example, SnOx, WOx, TiOx, TaOx, ZnO, InOx or the like, or tungsten oxide (WO_{2.72}), and a metal atom such as Pd, Pt, Ru, V, Cu, Au, Cd, Al or the like may be added to the metal oxide in order to adjust sensitivity and selectivity of the sensor.

The metal oxide nanoparticle may be fabricated using various methods such as a chemical vapor deposition (CVD) method, a synthetic method using arc, a template method using anode aluminum oxide or polycarbonate membrane polymer, a solvothermal method using heat and surfactant in solution, and so on. In the present invention, the metal oxide nanoparticles fabricated by the methods are separated and refined, and then, dispersed in solution. An ideal method may be the solvothermal method for synthesizing them in the solution.

The metal oxide nanoparticles dispersed in a solvent are applied using a drop coating (dispensing) method, a spin coating method, a spray coating method, or a dip coating method to form the sensing layer 106. At this time, preferably, the sensing layer 106 is formed to a thickness of about 0.1˜10 μm. The solvent may use an organic solvent, and when the dispersion is not performed due to low solubility between the solvent and the nanoparticles, the dispersion is induced using physical impact such as ultrasonic waves. In addition, the applied metal oxide nanoparticles include various solvent molecules to apply heat or maintain vacuum conditions to facilitate elimination of the solvent. If necessary, auxiliary additives capable of facilitating dispersion and improving characteristics of the nanoparticles may be mixed.

The chemical sensor of the present invention can detect the chemical species even at a low temperature of not more than 100° C. due to a large surface area of the metal oxide nanoparticle and an active adsorption site located at the surface. That is, the electrical conductivity is reversibly decreased or increased depending on adsorption or desorption of the gaseous chemical species to or from the sensing layer 13 or 106, therefore, the chemical species can be detected by measuring the varied electrical conductivity through the sensing electrode.

The heater 22, 31 or 104 of the present invention is capable of making a low temperature atmosphere of not more than 100° C., maintaining a constant temperature condition that is not affected by external environment, and rapidly removing the material adsorbed to the sensing layer 13 or 106.

FIG. 8 is a scanning electron microscope (SEM) photograph of a sensing layer made of a tungsten oxide nanorod structure. The tungsten oxide nanorod was synthesized by heating a mixed solution of W(CO)₆, Me₃NO2H₂O, and oleylamine at 270° C. As a result of the confirmation by the transmission electron microscope, it was confirmed that the nanorod fabricated as described above had an average length of about 75 nm and an average width of about 4 nm (See J. Am. Chem. Soc. 125(2003) 3408).

Meanwhile, the length and width of the tungsten oxide nanoparticle can be varied within a range of about 30˜140 nm and 2˜6 nm, respectively, by adjusting a reaction temperature and concentration of the oleylamine. That is, the metal oxide nanorod having an aspect ratio of 5˜70 and a short side length of 2˜6 nm can be manufactured. Solution dispersed in alcohol after treating surfactant existing on a surface of the nanorod using acid was applied using a drop coating method or a spin coating method to form a sensing layer, and a solvent was removed in 100° C. vacuum atmosphere for 12 hours. Referring to FIG. 8, it was appreciated that the nanorods were rod-shaped structures gathered together in a longitudinal direction.

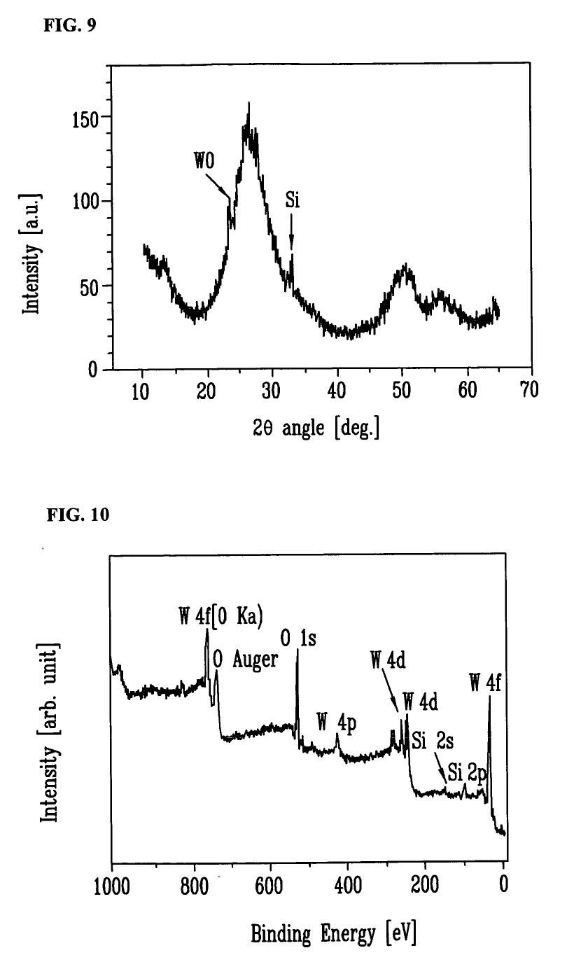

FIGS. 9 and 10 are an X-ray diffraction (XRD) spectrum and an X-ray photoelectron spectroscopy (XPS) spectrum of the sensing layer shown in FIG. 8.

Viewing from XRD, peaks having a large width were observed at a base line, and a small peak was observed at around 23°. It means that the thin layer is composed of nanoparticles having (010) crystalline properties. Viewing from XPS, W and O were observed as main components, and a minor amount of carbon was also observed. It means that carbon compound impurities still remain since they are not entirely removed. Peaks by other components could not be confirmed.

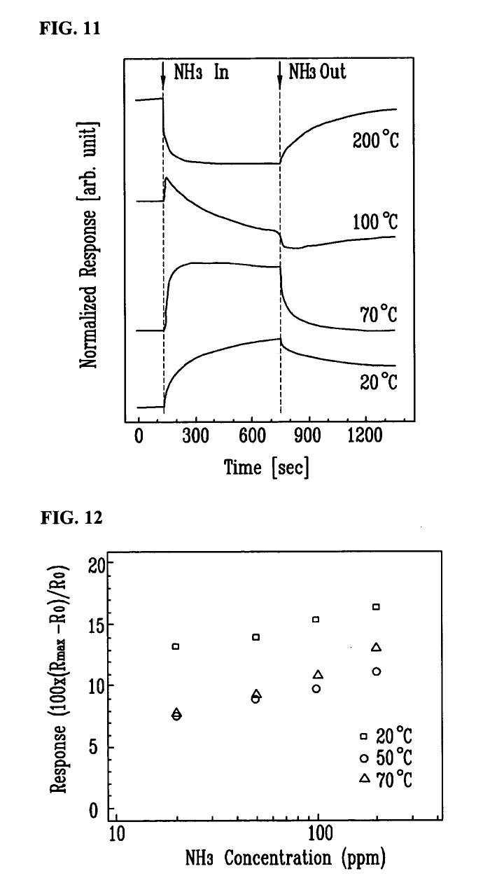

FIG. 11 is a graph showing sensing reaction to ammonia. The chemical sensor as shown in FIG. 6 including the heater 104 and the sensing layer 106 formed of the tungsten oxide nanorod was used. Sensing reaction is observed at the state exposed to an ammonia gas of 100 ppm through variations of resistance depending a temperature.

The resistance was decreased at a temperature of not less than 100° C. by ammonia, and increased at a temperature of not more than 100° C. The ammonia reacts with oxygen existing on a surface of the metal oxide at a high temperature so that an oxidation reaction occurs to increase electrical conductivity, and therefore, an energy barrier formed between the nanoparticles is decreased to decrease the resistance. Generally, this is well known fact. In the case of a low temperature, a contrary phenomenon is generated. It is suggested that a theory different from a general high temperature mechanism was related thereto. Generally, the nanoparticle has a large surface area in comparison with its volume, and a pore is readily formed on formation of a layer. Especially, since the tungsten oxide nanorod has a composition of WO_{2.74} other than WO₃ stable at bulk, in the case of the tungsten oxide nanorod, an active site readily participating to the reaction in comparison with the bulk exists. Actually, in the IR spectrum before/after exposure to ammonia is observed at a room temperature, it can be observed that the ammonia molecule being adsorbed to the tungsten oxide nanoparticle. Generally, the metal oxide nanoparticle has an acidic adsorption site to allow reduction carbonate compound, carbonate oxide, carbonate nitride, ammonia molecules for reducing the sensing layer to be readily adsorbed to the adsorption site. Therefore, in the case of the metal oxide nanoparticle capable of using active adsorption, it becomes easy to detect the reduction molecule.

FIG. 12 is a graph showing sensing characteristics depending on variations of ammonia concentration, illustrating sensitivity variations depending on ammonia concentration (log) at a low temperature.

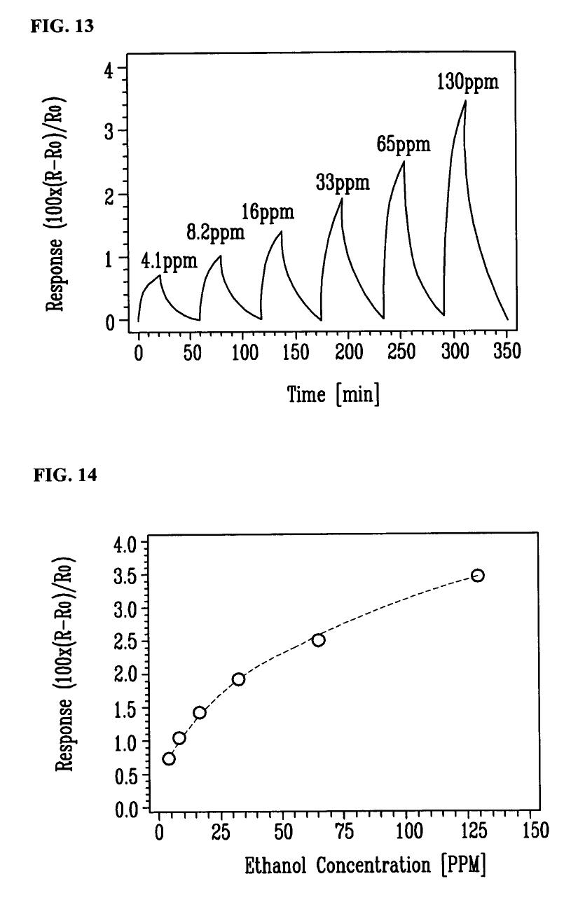

FIG. 13 is a graph showing sensing characteristics depending on an increase of ethanol concentration, and FIG. 14 is a graph showing sensitivity levels depending on variations of ethanol concentration, using the chemical sensor as shown in FIG. 1 employing the glass substrate 10.

Similar to the case of ammonia, it is appreciated that the sensitivity levels are linearly increased depending on the concentrations (log).

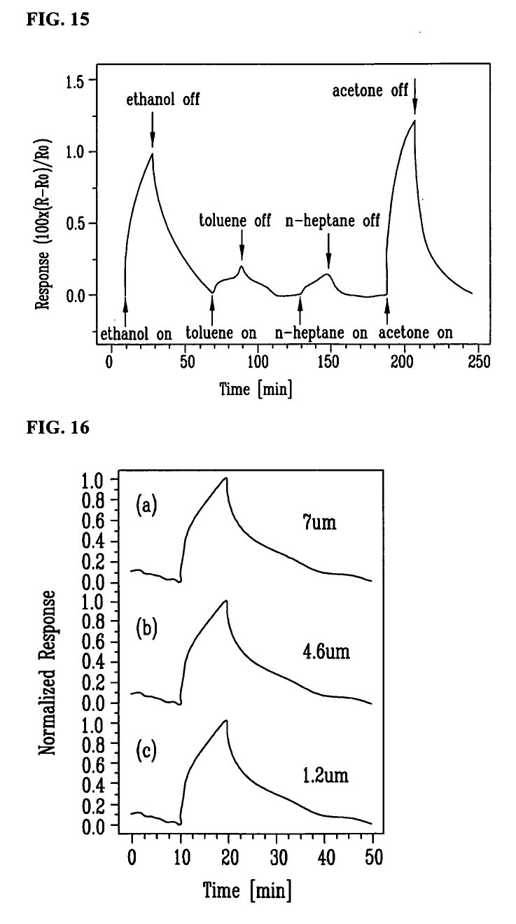

FIG. 15 is a graph showing sensing characteristics depending on injection and elimination of ethanol, toluene, n-heptanes, and acetone.

It was confirmed that the chemical sensor can react with various volatile organic materials through sensing characteristics depending on injection and elimination of acetone, n-heptanes, and toluene of 1˜10 ppm. It is appreciated that the chemical sensor may be used as a sensor for an electronic olfactory system for detecting a low concentration volatile organic material.

FIG. 16 is a graph showing sensing characteristics depending on thickness of a sensing layer, showing similar reaction time and recovering time regardless of a thickness. It is interpreted that molecules of the chemical species are easily penetrated into the sensing layer since the sensing layer has many pores.

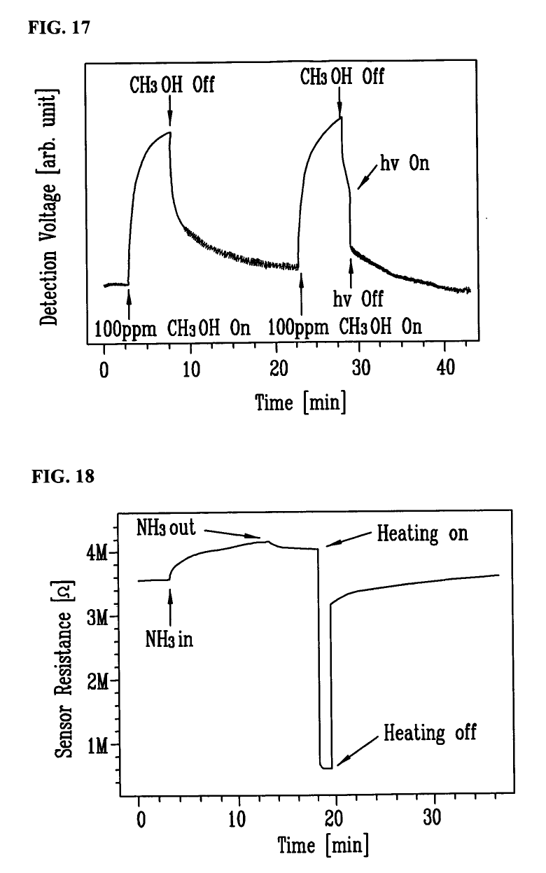

FIG. 17 is a graph showing sensing characteristics depending on injection and elimination of ethanol and variations of recovering time depending on UV light irradiation, and FIG. 18 is a graph showing sensing characteristics when a pulse voltage is applied to a heater.

In the case of the chemical sensor including the sensing layer formed of the tungsten oxide nanorod, since desorption speed of the molecules of the chemical species is very slow at a room temperature, it takes more than 20 minutes to recover its original state after detection. A method of irradiating light or applying heat may be performed in order to make the recovering time reduce, therefore, the chemical sensor of the present invention is also capable of reducing the recovering time by irradiating UV light or applying heat.

As can be seen from the foregoing, the present invention forms a sensing layer made of a metal oxide nanoparticle aggregate by applying solution that metal oxide nanoparticles are dispersed. Since electrical conductivity is varied depending on adsorption and desorption of the chemical species due to a large surface area of the crystalline metal oxide nanoparticle and an active adsorption site located at a surface thereof, it is possible to effectively detect a low concentration chemical species even at a low temperature. Therefore, since it is possible to prevent the sensor from deteriorating at a high temperature and to make the chemical sensor through a conventional semiconductor process, it becomes possible to adapt the chemical sensor to applications such as a system-on-chip (SOC), especially, a portable chemical sensor system requiring low power and ultra-small size, an ultra-small size chemical sensor system, and a sensor networking applications.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A chemical sensor for detecting a gaseous chemical species, comprising:
a sensing layer at which the chemical species is adsorbed, and
at least two electrodes for measuring an electrical conductivity of the sensing layer,
wherein the sensing layer is formed of a metal oxide nanoparticle aggregate having an aspect ratio of 5 to 70, and a short side length of 2 to 6 nm.

2. The chemical sensor according to claim 1, wherein the metal oxide nanoparticle is one selected from SnOx, WOx, TiOx, TaOx, ZnO, InOx, and a material that a metal atom is added to the metal oxide.

3. The chemical sensor according to claim 2, wherein the metal atom is one selected from Pd, Pt, Ru, V, Cu, Au, Cd, and Al.

4. The chemical sensor according to claim 1, wherein the metal oxide nanoparticle is one selected from WO_{2.72}, and metal atom added WO_{2.72} having a length of 30 to 140 nm and a width of 2 to 6 nm.

5. The chemical sensor according to claim 4, wherein the metal atom is one selected from Pd, Pt, Ru, V, Cu, Au, Cd, and Al.

6. The chemical sensor according to claim 1, wherein the sensing layer has a thickness of 0.1 to 10 μm.
